(19) United States
(12) Patent Application Publication
(10) Pub. No.: US 2011/0173316 A1
(43) Pub. Date: Jul. 14, 2011

(54) RELATIONSHIP BASED REPRESENTATION OF PARTICIPANTS IN SHARED ONLINE SPACE

(75) Inventors: George Moromisato, Seattle, WA (US); Karen Donoghue, Cambridge, MA (US); Jason E. Schleifer, Cambridge, MA (US); Sook Yeon Kim, Cambridge, MA (US)

(73) Assignee: c/o Microsoft Corporation, Redmond, WA (US)

(21) Appl. No.: 12/686,480

(22) Filed: Jan. 13, 2010

(51) Int. Cl. G06F 3/01; G06F 15/16

(52) U.S. Cl. 709/224; 715/753

(57) ABSTRACT

One or more techniques and/or systems are disclosed for presenting members of a shared online space to a user of the shared online space. A relationship value is determined between the user and a member of the shared online space by: determining an interaction value for the user and member relationship based on the user's and member's co-presence in the shared online space; determining a social network value for the user and member relationship based on a number of social network connections between the user and member; and combining the interaction value and social network value. The relationship value is associated with a specified visual representation of the member used in the shared online space, and two or more visual representations of members are scaled in the user's display in the shared online space in order to fit an available screen space, based on the relationship value.

### BACKGROUND

In a computing environment, an online community or virtual community is made up of a group of people that primarily interact using online communication media such as Internet-based news, email, Internet-based social networking sites, chat rooms, forum discussions and instant messaging, for example, rather than in person. Often, the online community is used for entertainment, social, professional, educational and/or other purposes. Online communities can supplement relational communication between people who know each other in real life, and are also often a primary form of communication between those who rarely meet in person, but may maintain close online relationships.

Many types of programs, services and software, separately or in combination, are used for online social networking and communications, including social networking sites, online game sites, online chat rooms and forums that use voice, video text and/or avatars. Recently, online communities utilize a shared online environment that provides for users to interact with each other, such as a social site, virtual world or online game, and/or collaborate or follow each other, such as in microblogging, blogging, online meetings, presentations, and live forum discussions.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

In a shared, public online experience with associated participants (e.g., members of the shared online space), presenting the participant population through a user interface (UI) that allows the user to readily identify and discriminate between a plurality of members can be challenging. For example, many users of online social networking sites have well over a hundred connections (e.g., “friends”), which they follow and interact with. However, current systems merely display the members in a same fashion (e.g., having a same prominence in the display area), and provide some rudimentary sorting, such as by time of update or alphabetically.

Further, present shared online spaces typically use some type of avatar or other visual representation to identify a participant member to the user. When a shared online space comprises a large number of participants with which the user interacts, a problem of scale arises when many participants are attempting to do something online together, or over a period of time and are represented as updates on the user's display. For example, it may be hard to identify relationships between participants when each participant's avatar is treated relatively equally in the user's display. That is, the user may have difficulty identifying those members with which they have a close and ongoing relationship, from those with a more distant relationship; often creating frustration when attempting to collaborate or communicate in the shared online space.

One or more techniques and/or systems are disclosed that can present the user with a user interface that adapts to how participant avatars, for example, are displayed in the available display space of the shared online space. The adaptation can allow for those member participants having a closer online relationship with the user to have their avatars displayed more prominently (e.g., larger) than those having a more distant online relationship. Further, the avatars can be arranged and scaled in the display in a manner that fills the display area, or accommodates a particular size, while maintaining the visual distinctions based on the closeness of the relationship.

In one embodiment for presenting members of a shared online space to a user of the shared online space, a relationship value can be determined between the user and a member of the shared online space. To determine the relationship value, an interaction value can be determined for the user and member relationship that is based on the user's and member's co-presence in the shared online space (e.g., being logged into the same site at the same time). Further, to determine the relationship value, a social network value can be determined for the user and member relationship that is based on a number of social network connections between the user and member, such as following feeds, and/or social connections online. The interaction value and social network value can be combined for the user and member to determine the relationship value.

In this embodiment, the relationship value can be associated to a specified visual representation of the member used in the shared online space. Further, two or more visual representations of members can be scaled in the user's display in the shared online space in order to fit an available screen space. The scaling can be based on the relationship value, for example, such that a higher relationship value yields a larger representation in the display.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary environment where aspects of one or more of the techniques and/or systems described herein may be implemented.

FIG. 2 is a flow diagram illustrating an exemplary method for presenting members of a shared online space to a user of the shared online space.

FIG. 3 is a flow diagram illustrating one exemplary embodiment of a method for determining the interaction value.

FIG. 4 is a flow diagram illustrating one embodiment of at least a portion of a method for determining a relationship value.

FIG. 5 is a diagram illustrating one exemplary embodiment of how member representations can be displayed in an online shared space.

FIG. 6 is a component diagram illustrating one embodiment of how semantic application data can be applied to member images.

FIG. 7 is a component block diagram of an exemplary system for presenting members of a shared online space to a user of the shared online space.

FIG. 8 is a component block diagram illustrating an exemplary embodiment of at least a portion of an implementation of a system described herein.

FIG. 9 is an illustration of an exemplary computer-readable medium comprising processor-executable instructions configured to embody one or more of the provisions set forth herein.

FIG. 10 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

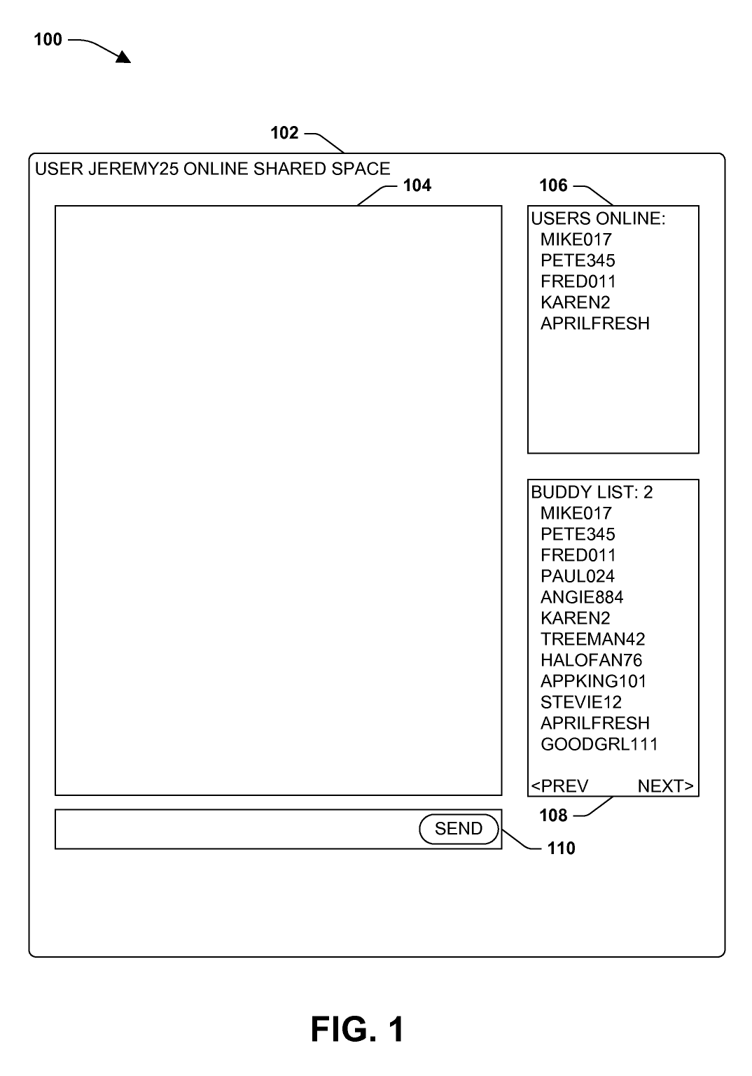

FIG. 1 is an illustration of an exemplary environment 100 where aspects of one or more the techniques and/or systems described herein may be implemented. The exemplary environment 100 comprises a shared online space 102, such as a web-based chat room (e.g., comprised in a social networking site, an online collaboration site, an online gaming site, etc.). While social networking sites and other sites where users link with other members are often used for a variety of purposes (e.g., games, professional development, fantasy, social interaction, etc.) they are commonly used to chat with other members. Here, a chat area 104 may show the chat as it happens, and the user can send chats to the chat room using the chat bar 110.

In this example, the shared online space 102 comprises a list of connections 108 for the user (Jeremy25), sometimes referred to as a buddy list. The buddy list 108 typically comprises a list of members of the shared online space 102 with which the user (Jeremy25) has a connection (e.g., friend). Further, a list of those “buddies” currently online 106 is displayed, which allows the user to identify who he may chat or interact with while in the shared online space 102. Here, the buddies in the buddy list 108 and online user list 106 are shown as member names, and may be listed in any particular order, depending on how the space applies this feature, such as alphabetical, by time of log-in, etc.

A method may be devised that can provide a user with a user interface, for example, that adapts how members connected to the user (e.g., participants in a shared online space) are displayed to the user. Images of the members can be displayed based on a strength of a relationship between the user and respective members, for example, where members having a closer relationship with the user are displayed more prominently than those having a more distant relationship, at least online. In this way, for example, the presentation of participant members can grow and scale “organically,” that is, adapting to a number of members and relationships without visual jarring in the available display space.

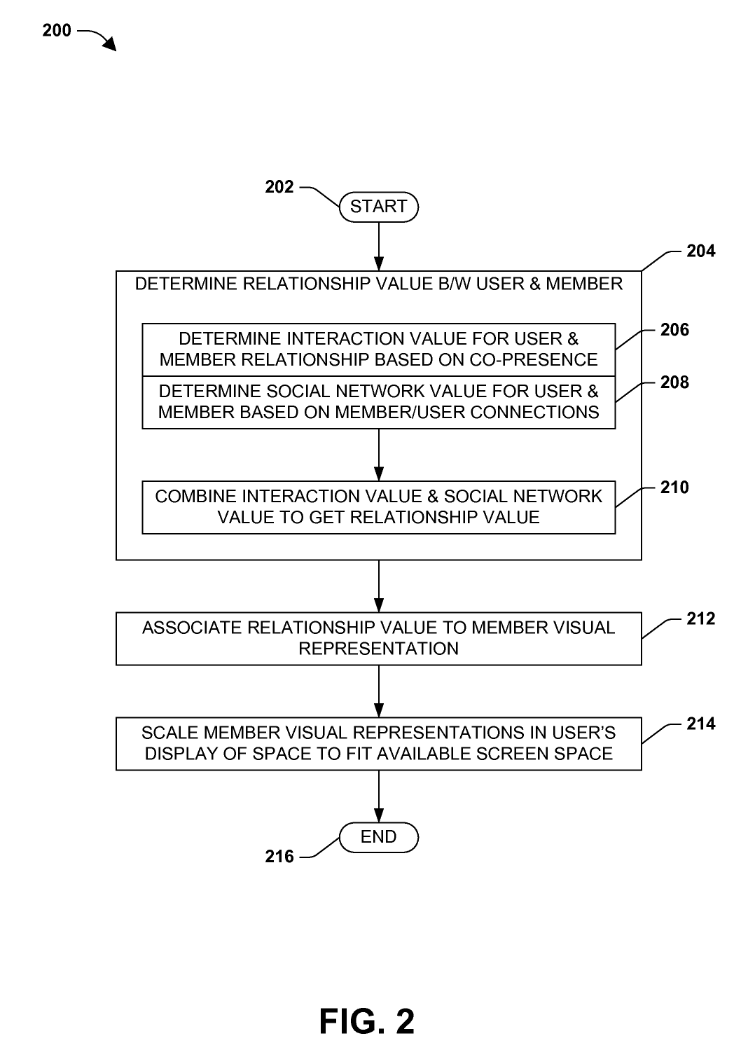

FIG. 2 is a flow diagram illustrating an exemplary method 200 for presenting members of a shared online space to a user of the shared online space. The method 200 begins at 202, and involves determining a relationship value between the user and a member of the shared online space, at 204. For example, the user may have a plurality of members (e.g., contacts, friends, connections, etc.) in their shared online space, such as a social networking website. In one embodiment, a relationship value can be determined between the user and each of the members, for example, where a number of relationship values are equivalent to a number of members in the user's shared online space.

At 206, determining a relationship value between the user and a member of the shared online space comprises determining an interaction value for the user and member based on the user's and member's co-presence in the shared online space. For example, the user may have a connection with the member is a particular shared online space, such as a peer collaboration website. In this example, the interaction value for the user and member relationship can be a function of instances where both the user and member are logged into the shared online space at a same time.

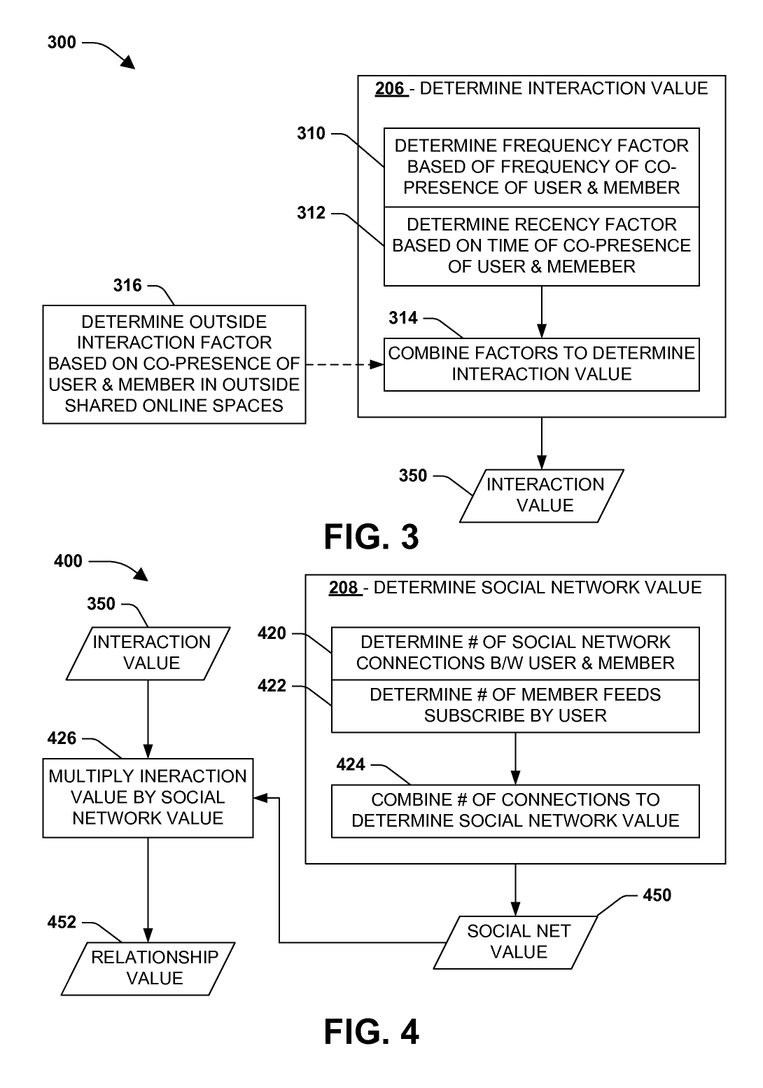

In one aspect, the interaction value can comprise a plurality of factors that are combined to determine the interaction value, for example. In one embodiment, the interaction value may comprise a combination of a frequency factor and a recency factor. In another embodiment, the interaction value may comprise a combination of a frequency factor and a recency factor from the user's shared online space, combined with an interaction factor from one or more other shared online spaces utilized by both the user and the member. FIG. 3 is a flow chart diagram illustrating one exemplary embodiment 300 of a method for determining the interaction value, such as at 206 in FIG. 2.

At 310, a frequency factor can be determined for the user and member based on a frequency of a shared co-presence in the shared online space. For example, for every ten times that the user is logged onto the shared online space the member may be logged on at the same time four times. In this example, the user and member share a co-presence in the shared online space forty percent of the time that the user is logged on. Therefore, in this example, a frequency factor of 0.4 may be applied to the user and member relationship for the shared online space. In this embodiment, the frequency factor can be dynamically determined at any particular time, as the frequency of the user and member's co-presence may change. In this way, for example, members that are co-present with the user in the shared online space more frequently may represent those members having a closer relationship with the member.

It will be appreciated the above example is merely one embodiment of determining a frequency factor, and it is anticipated that those skilled in the art may devise alternate ways to determine a frequency factor. For example, additional factors or calculations may be used, such as an amount of time the co-presence encompasses, may be used as a factor to weight respective con-presence instances.

At 312, a recency factor may be determined for the user and member based on a time of the shared co-presence in the shared online space relative to a current time. For example, a recency factor can be used to identify whether the co-presence of the user and member is more recent or older. As an illustrative example, a recency factor of one may be applied to a current co-presence, and a sliding scale down from one can be applied to previous co-presences based on the time and/or date back to a preset time and/or date (e.g., one month). In this way, for example, members that are co-present with the user in the shared online space more recently may represent those members having a closer relationship with the member.

It will be appreciated that the above example is merely one embodiment of determining a recency factor, and it is anticipated that those skilled in the art may devise alternate ways to determine a recency factor. For example, additional factors or calculations may be used, such as using a recency factor that comprises a number of seconds, minutes, hours or days from the current time to the co-presence instance to which the recency factor is applied.

At 314 in the exemplary embodiment 300, the frequency factor and recency factor can be combined to determine the interaction value 350. For example, the user and member may have four co-presences out of the user's last ten presences in the shared online space. In this example, the recency factor may utilize a sliding scale from one to zero divided into a scale of 30 units for one month from the current time. A first co-presence may be a current co-presence (e.g., the user and member are both currently logged onto the shared online space) resulting in a recency factor of one being applied to this co-presence. Based on the other co-presences occurring on days prior to the current day a second, third and fourth co-presence may have recency factors of 0.93, 0.63 and 0.33 respectively.

In this example, a result of combining the frequency factor and recency factor can be 0.289 (e.g., adding the recency factors for the respective frequencies of the co-presences: 1.0+0.93+0.63+0.33=2.89, dividing by the number of total user presences: 2.89/10=0.289). This example illustrates how the frequency of user/member co-presence can be reduced from forty percent to twenty eight point nine percent based on the recency of the co-presences. It will be appreciated that the above example is merely one embodiment of combining the frequency factor and recency factor, and it is anticipated that those skilled in the art may devise alternate ways to combine these factors to determine the interaction value 350. That is, the claimed subject matter is not intended to be limited to the foregoing example.

In another embodiment, at 316, an outside interaction factor for the user and member can be determined using a factor that is based on co-presence of the user and member in one or more outside shared online spaces. For example, the user may share one or more connections or interactions with the member in one or more other shared online spaces (e.g., other than the one for which a relationship value is being determined). In this example, a user/member interaction value for the respective other shared online spaces can be determined, such as by using the techniques described above, and combined. The combination of the interaction values from the other spaces can be used as an outside interaction value, in this example.

Further, a 314, the interaction value 350 can be determined for the user and member relationship by combining the outside interaction factor, frequency factor and recency factor. It will be appreciated that other factors may be used to determined the interaction value 350, and the above described examples are merely described herein for illustrative purposes. The techniques and systems described herein are not limited to these examples.

Returning to the exemplary method 100 of FIG. 1, a social network value is determined for the user and member relationship based on a number of social network connections between the user and member, at 208. For example, the user and member may be friends on a social networking website, members of an online collaboration website, following each other on a microblogging website, and the user may subscribe to the member's blog. In this example, these four connections between the user and member can be used to determine a social network value (e.g., four connections=a social network value of 4).

In one embodiment, determining the social network value based on a number of social network connections between the user and member can comprise determining a number of connections between the user and member on social network sites. For example, there are websites dedicated to social networking online between people (e.g., MySpace, Facebook, LinkedIn, etc.), and there are multi-content websites that also utilize social networking (e.g., MSN, Yahoo, Google, etc.). In this example, people connect with each other on the social network sites by sending a request to be connected to another, and the request being accepted, thereby creating a connection. The number of connections between the user and member can be counted, for example, as part of the social network value. Further, in one embodiment, a number of connections may comprise indirect connections, such as those connected to direct connections (e.g., connections of connections, friends of friends, possibly capped by a predetermined degree of separation).

Further, determining the social network value based on a number of social network connections between the user and member can comprise determining a number of online member feeds subscribed to by the user. For example, an online feed can comprise periodic updates to a status, blog, newsletter, and many more. In this example, generally, a feed comprises some form of information that is periodically (e.g., at regular or irregular intervals) updated online. Here, a number of member feeds, such as the member's status updates on various websites, blogs, etc., that the user subscribes to (e.g., follows) can be counted toward the social network value.

In another embodiment, additional online connections, interactions and/or mutual content may be used to determine one or more social network connections (e.g., since users and members interact with each other online in a variety of ways). For example, a user may appear and be tagged in a photograph on the member's shared online space (e.g., homepage, Facebook page, etc.), and vice-versa. In another example, a member may comment on a user's feed in a shared online space (e.g., the shared online space, and/or a third party shared online space), or vice-versa. Additionally, as another example, the user may invite the member to an event using the shared online space (e.g., either online or in person), or vice-versa. In this embodiment, any one or all of these (and others) may be used to count toward social network connections, thereby counting toward the social network value. That is, the social network value may also take into consideration and/or be influenced by users and/or members having content in common with one another, such as, for example, appearing in each others' photos, commenting on each others' status in a social medium and/or forum, pulling social connectedness from some 3^{rd} party service, etc.

Returning to the exemplary method 200 of FIG. 2, at 210, the interaction value and social network value are combined to get a relationship value for the relationship between the user and the member for the shared online space. FIG. 4 is a flow diagram illustrating one embodiment 400 of a portion of a method for determining a relationship value. In this embodiment 400, as described above, when determining the social network value (e.g., at 208 of FIG. 2), a number of social network connections between the user and member is determined, at 420. Further, at 422, a number of member feeds subscribed to by the user is determined.

At 424, the number of connections is combined to determine the social network value 450. For example, if the user and member have four social network connections, and the user subscribes to three member feeds, the social network value can be seven (e.g., four+three). In this exemplary embodiment 400, the interaction value (e.g., 350 from FIG. 3) can be combined with the social network value 450 by multiplying the two values together, at 426, to get the relationship value 452. For example, a social network value of seven can be multiplied by a interaction value of 0.289 to yield a relationship value of 2.023.

At 212 in the exemplary method 200 of FIG. 2, the relationship value is associated with a specified visual representation of the member used in the shared online space. In one embodiment of a user's shared online space, when members are online a visual representation of the member is displayed. For example, instead of merely displaying a member's name, such as shown in 106 and 198 of FIG. 1, an image can be displayed for the member, such as a picture of the member or some other image. In this way, in this example, a more user-friendly environment may be created, where the user's connected members can be more readily identified by an image. In this embodiment, the relationship value is attached to the image for the member.

At 214, two or more visual representations of members are scaled in a display of the user's shared online space to fit an available screen space based on the relationship value. FIG. 5 is a diagram illustrating one exemplary embodiment 500 of how member representations can be displayed in the online shared space. The exemplary embodiment 500 may comprise a social networking site that utilizes a chat area 502, as described above, and a member display area 504. Here, the member display area 504 displays visual representations (images) for respective members that are connected to the user in the shared online space.

As described above, the member images can be scaled to fill the available space of the member display area 504, based on the relationship value. In one embodiment, the visual representations of the members can be scaled where the visual representation of a first member 506 is larger than the visual representation of a second member 508, as the first member's relationship value is higher than the second member's relationship value. That is, for example, a size of the member image is increased or reduced based on the relationship value, so that those members with higher values have larger images.

In one embodiment, the visual representations of members can be scaled to a desired size in the display 504 based on the relationship value falling within a range of relationship values associated with the desired size. That is, in this exemplary embodiment 500, those members having a relationship value in the highest three of all member relationship value can be represented by larger scaled images 506; those having a relationship value among the next four highest can be represented by a medium sized image 508; and those members having the next sixteen highest values can be represented by a small sized image 510. In this way, for example, those members having a closer relationship with the user, based on the higher relationship value, are displayed more prominently in the member display area 504, using a desired size (e.g., large, medium, small), enabling the user to interact with them more readily.

In another embodiment, different visual treatments may be applied to the visual representations of the members (e.g., as in the display area 504 of FIG. 5). The desired visual treatments can be applied to the visual representations of the members in the display of the user's online space based on the relationship value associated with respective member representations. For example, the images can be altered in other ways other than (or as well as) size. In one embodiment, different color schemes may be applied to the member images, such as using brighter colors for those members having a higher relationship value with the user, and applying the color scheme to the member images using a sliding scale (e.g., bright red for the top 3, orange for the next 4, and yellow for the next 16).

In another embodiment, dynamic visual properties can be applied to the member image, as associated with portion of the scale of the relationship values. For example, where members have a higher relationship value their image may have more dynamic properties, such as animation, movement, and/or actions (e.g., sparkle, change colors, etc.). In another embodiment, the location of the member's displayed image can depend on the portion of the scale of the relationship values. For example, where members have a higher relationship value their image may be placed higher in the display area; and for those with a lower relationship value, their image may be placed lower in the display area.

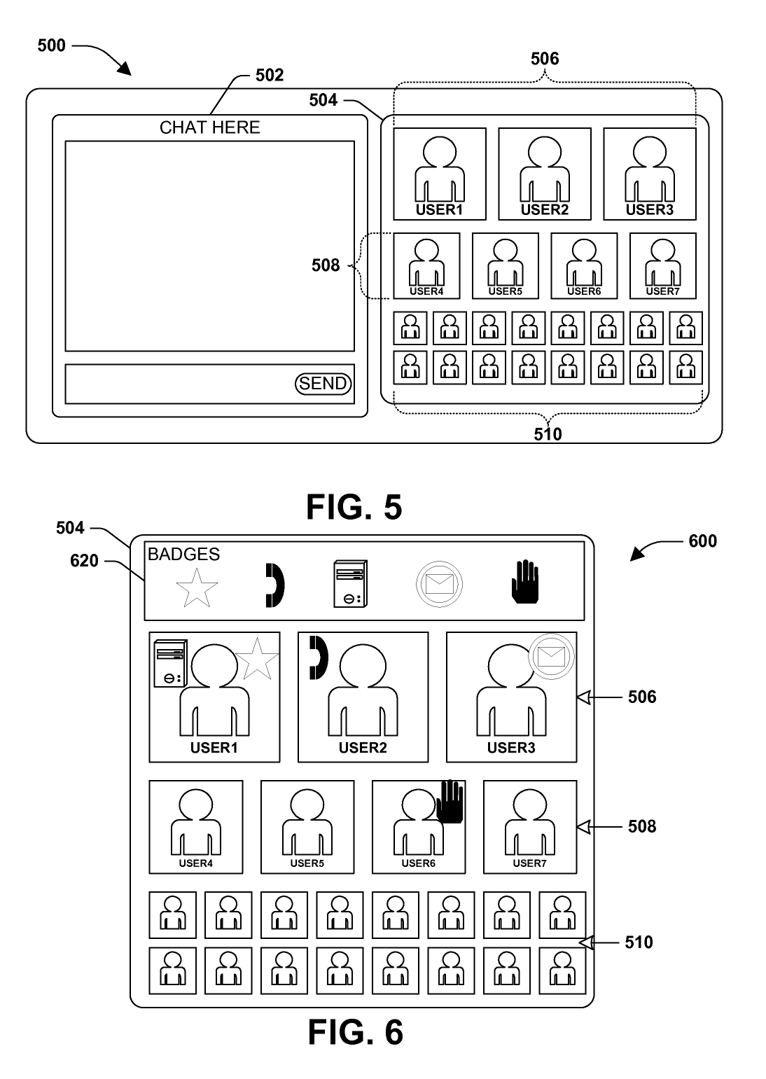

In one aspect, semantic application data can be applied to the visual representations of the members displayed in the member display area (e.g., 504 of FIG. 5). In one embodiment, a badge component can be attached to the visual representation (image) of the member that represents available semantic application data. FIG. 6 is a component diagram illustrating one embodiment 600 of how semantic application data can be applied to member images. In the exemplary embodiment 600, a member display area 504 of the user's shared online space displays visual representations of the members 506, 508, 510 connected to the user. Further, available “badges” 620 are displayed, as a type of key and/or menu for the user.

In one embodiment, available semantic application data can comprise an application that when activated causes an online action to be performed on the member's visual representation. For example, the star badge 620 may be applied to a member 506, which when activated (e.g., clicked on, or moved to the member image) causes the member image to sparkle or light up. As another example, the hand badge 620 may be applied to a member's visual representation 508, which when activated cause the hand to wave to the member on their shared online space display. In this way, users and member can interact with each other without actually “chatting.”

In another embodiment, the available semantic application data can identify things about the member. For example, a badge may identify semantic information about the member's activity status online, such as what they are currently doing online (e.g., are they available to chat, busy, working on something, etc.), and whether they have sent a message to the user, indicated by the envelope badge 620 applied to the member 506. Further, the semantic application data can identify semantic information about the member's permissions with the shared online space. For example, is the member merely one who uses the online space, are they an administrator, helper, or someone with editing permissions, etc.

Additionally, the semantic application data can identify semantic information about the member's method of connection to the shared online space. For example, members may access the shared online space using a laptop, netbook, mobile smart phone, desktop, etc. A variety of badges, such as a computer or telephone 620, can be applied to the members 506 indicating their mode of connection to the shared online space. In this way, for example, the user may be able to know whether the member is at home, work, or mobile.

A system may be devised that can provide a user with a user interface, for example, that adapts how members connected to the user (e.g., participants in a shared online space) are displayed to the user. Images of the members can be displayed based on a strength of a relationship between the user and respective members, for example, where members having a closer relationship with the user are displayed more prominently than those having a more distant relationship, at least online. In this way, for example, the presentation of participant members can grow and scale “organically,” that is, adapting to a number of members and relationships without visual jarring in the available display space.

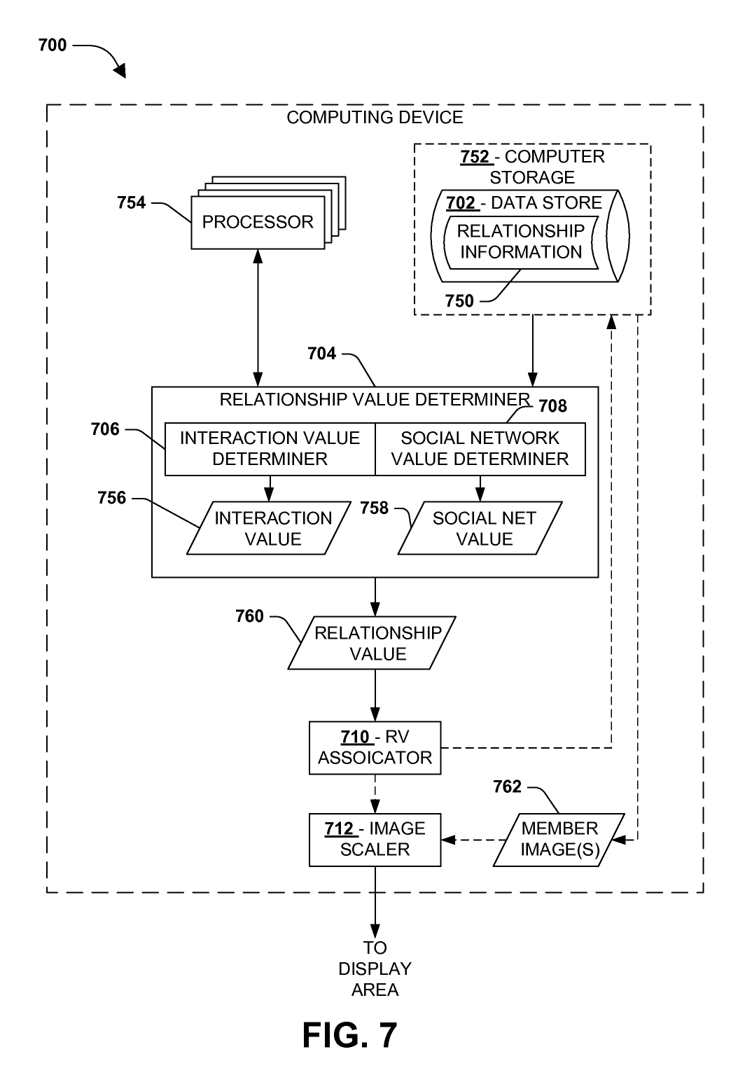

FIG. 7 is a component block diagram of an exemplary system 700 for presenting members of a shared online space to a user of the shared online space. A data store 702 is disposed in computer-based storage 752, such as in a computing device, and stores information used in determining a relationship value between the user and a member of the shared online space. A relationship value determination component 704 is operably coupled with the data store 702 and one or more computer-based processors 754, for example, in the computing device, and it retrieves information from the data store 702 and utilizes the one or more processors 754 to determine a relationship value 760 between the user and the member of the shared online space.

The relationship value determination component 704 comprises an interaction value determination component 706 that utilizes information about the user's and member's co-presence in the shared online space, such as from the relationship information 750 stored in the data store 702, to determine an interaction value 756. Further, the relationship value determination component 704 comprises a social network value determination component 708 that uses information about the member's online feeds subscribed to by the user to determine a social network value 758. Additionally, the relationship value determination component 704 combines the interaction value 756 and social network value 758 for the user and member to generate the relationship value 760.

A relationship value association component 710 associates the relationship value with a corresponding member visual representation. In one embodiment, the corresponding member visual representation for the relationship value may be identified in the data store 702 (e.g., stored in the data store), and the relationship value calculated for that member/user relationship can be attached to (e.g., stored with) the member's visual representation in the data store 702. In another embodiment, the relationship value 760 (RV) can merely be associated with the member's visual representation by attaching some tag or identified to the RV.

An image scaling component 712 scales respective two or more visual representations of members in a display of the user's shared online space to fit an available screen space based on the relationship value. For example, in one embodiment, a member image 762 can be retrieved from the data store 702, and the image scaling component 712 can scale the image 762 according to the RV associated with the member image. In this example, the larger the RV the larger the image is scaled in the available display space.

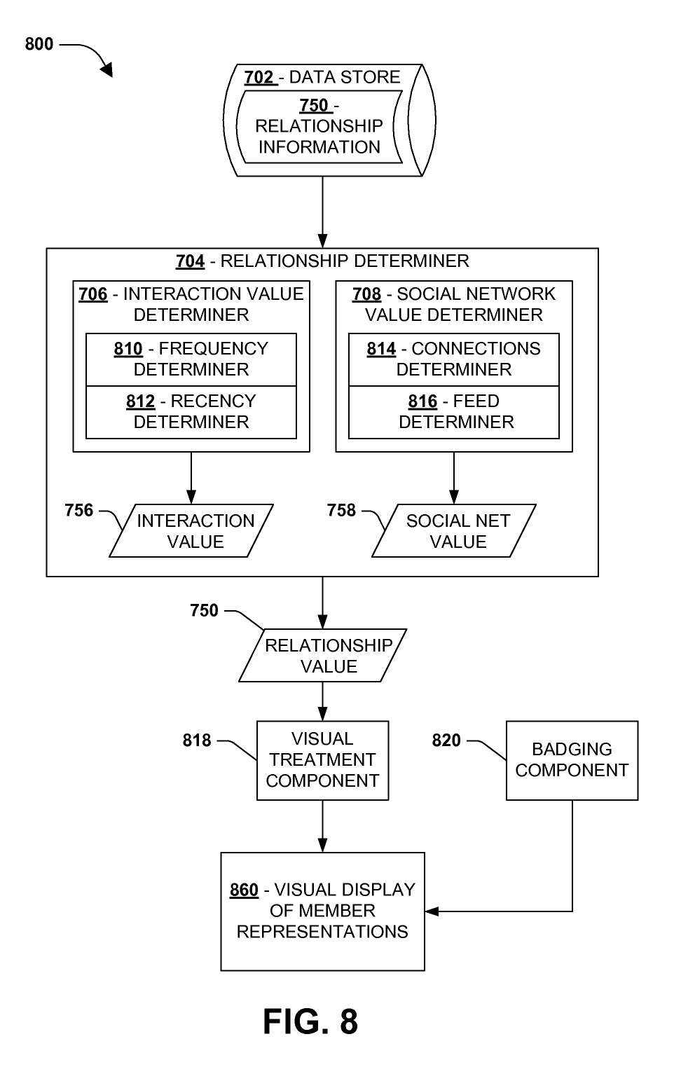

In one embodiment, as illustrated in the exemplary embodiment 800 of a portion of an implementation of systems described herein, in FIG. 8, the interaction value determination component 706 can comprise a frequency determination component 810 and a recency factor determination component 812. In this embodiment, the frequency determination component 810 can determine a frequency factor for the user and member based on a frequency of a shared co-presence in the shared online space. Further, the recency factor determination component 812 can determine a recency factor for the user and member based on a time of the shared co-presence in the shared online space relative to a current time. Additionally, the interaction value determination component 706 can combine the frequency factor and recency factor to generate an interaction value 756.

In this exemplary embodiment 800, the social network value determination component 708 can comprise a connections determination component 814 and a feed determination component 816. The connections determination component 814 can determine a number of connections between the user and member on social network sites, and the feed determination component 816 can determine a number of online member feeds subscribed to by the user. Further, the social network value determination component 708 can combine the number of connections and number of feeds to determine the social network value 758.

In one embodiment, the exemplary system may comprise a visual treatment component 818 that applies a desired visual treatment to visual representations of the members in the display of the user's online space 860 based on the relationship value associated with respective member representations. That is, as an alternate to scaling the images of the members, or in addition to, the member images may be visually altered by the visual treatment component 818 to identify a sort of hierarchical scheme based on the RV for the member/user relationship. As an example, a color scheme may be applied, the images may be dynamically changed, or other visual alterations can be applied.

In one embodiment, the image scaling component (e.g., 712 of FIG. 7) can scale visual representations of members in the user's display area 860 according to the RV assigned to respective visual representations, where a first member's visual representation is scaled larger than a second member's visual representation if the first member's relationship value is higher than the second member's relationship value. That is, for example, the larger the RV for the member image, the larger the member image is scaled in the available space of the display area 860. In this way, in this example, the display space can be filled according to a number of members present and the respective RV for the members.

In one embodiment, a badging component 820 can be used in the exemplary embodiment of the system 800, and it may be used to attach a badge component to the visual representation in the display area 860 of the member that identifies available semantic application data. For example, where a user may wish to know how the member is connected to the shared online space, a badge may be attached that shows a computer, indicating the member is connected by a desktop. Further, the badge may be activated and perform an action on the image of the member, such as waving to the member on their display.

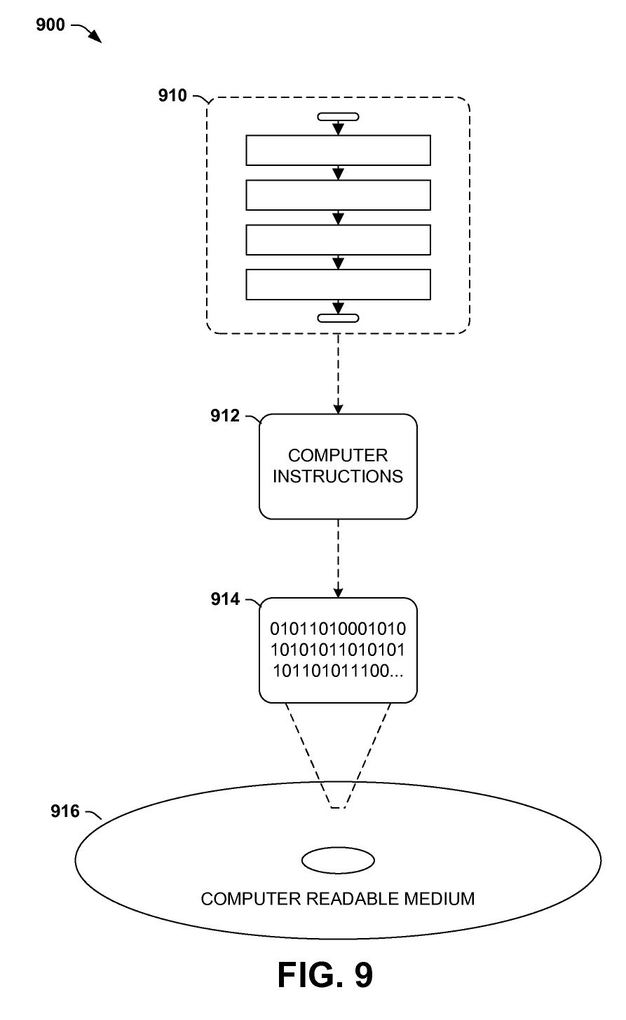

Still another embodiment involves a computer-readable medium comprising processor-executable instructions configured to implement one or more of the techniques presented herein. An exemplary computer-readable medium that may be devised in these ways is illustrated in FIG. 9, wherein the implementation 900 comprises a computer-readable medium 908 (e.g., a CD-R, DVD-R, or a platter of a hard disk drive), on which is encoded computer-readable data 906. This computer-readable data 906 in turn comprises a set of computer instructions 904 configured to operate according to one or more of the principles set forth herein. In one such embodiment, the processor-executable instructions 904 may be configured to perform a method 902, such as the exemplary method 200 of FIG. 2, for example. In another such embodiment, the processor-executable instructions 904 may be configured to implement a system, such as the exemplary system 700 of FIG. 7, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

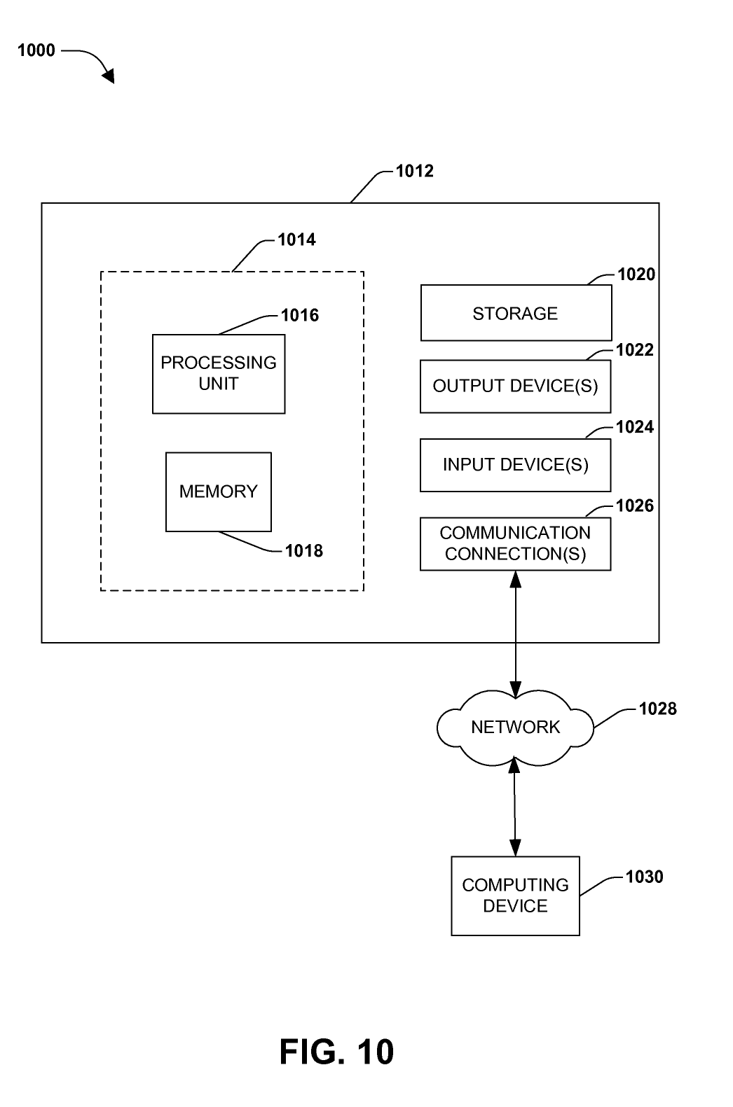

FIG. 10 and the following discussion provide a brief, general description of a suitable computing environment to implement embodiments of one or more of the provisions set forth herein. The operating environment of FIG. 10 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 10 illustrates an example of a system 1010 comprising a computing device 1012 configured to implement one or more embodiments provided herein. In one configuration, computing device 1012 includes at least one processing unit 1016 and memory 1018. Depending on the exact configuration and type of computing device, memory 1018 may be volatile (such as RAM, for example), non-volatile (such as ROM, flash memory, etc., for example) or some combination of the two. This configuration is illustrated in FIG. 10 by dashed line 1014.

In other embodiments, device 1012 may include additional features and/or functionality. For example, device 1012 may also include additional storage (e.g., removable and/or non-removable) including, but not limited to, magnetic storage, optical storage, and the like. Such additional storage is illustrated in FIG. 10 by storage 1020. In one embodiment, computer readable instructions to implement one or more embodiments provided herein may be in storage 1020. Storage 1020 may also store other computer readable instructions to implement an operating system, an application program, and the like. Computer readable instructions may be loaded in memory 1018 for execution by processing unit 1016, for example.

The term “computer readable media” as used herein includes computer storage media. Computer storage media includes volatile and nonvolatile, removable and non-removable media implemented in any method or technology for storage of information such as computer readable instructions or other data. Memory 1018 and storage 1020 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1012. Any such computer storage media may be part of device 1012.

Device 1012 may also include communication connection(s) 1026 that allows device 1012 to communicate with other devices. Communication connection(s) 1026 may include, but is not limited to, a modem, a Network Interface Card (NIC), an integrated network interface, a radio frequency transmitter/receiver, an infrared port, a USB connection, or other interfaces for connecting computing device 1012 to other computing devices. Communication connection(s) 1026 may include a wired connection or a wireless connection. Communication connection(s) 1026 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1012 may include input device(s) 1024 such as keyboard, mouse, pen, voice input device, touch input device, infrared cameras, video input devices, and/or any other input device. Output device(s) 1022 such as one or more displays, speakers, printers, and/or any other output device may also be included in device 1012. Input device(s) 1024 and output device(s) 1022 may be connected to device 1012 via a wired connection, wireless connection, or any combination thereof. In one embodiment, an input device or an output device from another computing device may be used as input device(s) 1024 or output device(s) 1022 for computing device 1012.

Components of computing device 1012 may be connected by various interconnects, such as a bus. Such interconnects may include a Peripheral Component Interconnect (PCI), such as PCI Express, a Universal Serial Bus (USB), firewire (IEEE 1394), an optical bus structure, and the like.

In another embodiment, components of computing device 1012 may be interconnected by a network. For example, memory 1018 may be comprised of multiple physical memory units located in different physical locations interconnected by a network.

Those skilled in the art will realize that storage devices utilized to store computer readable instructions may be distributed across a network. For example, a computing device 1030 accessible via network 1028 may store computer readable instructions to implement one or more embodiments provided herein. Computing device 1012 may access computing device 1030 and download a part or all of the computer readable instructions for execution. Alternatively, computing device 1012 may download pieces of the computer readable instructions, as needed, or some instructions may be executed at computing device 1012 and some at computing device 1030.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for presenting members of a shared online space to a user of the shared online space, comprising:
determining a relationship value between the user and a member of the shared online space, comprising:
determining an interaction value for a user and member relationship based on the user's and member's co-presence in the shared online space;
determining a social network value for the user and member relationship based on a number of social network connections between the user and member; and
combining the interaction value and social network value for the user and member;
associating the relationship value to a specified visual representation of the member used in the shared online space; and
scaling respective two or more visual representations of members in a display of the user's shared online space to fit an available screen space based on the relationship value.

2. The method of claim 1, comprising attaching a badge component to the visual representation of the member that represents available semantic application data.

3. The method of claim 2, available semantic application data comprising an application that can initiate execution of an online action relative to the member's visual representation upon activation.

4. The method of claim 2, available semantic application data comprising an application that can identify one or more of the following:
semantic information about the member's activity status online;
semantic information about the member's permissions with the shared online space; and
semantic information about the member's method of connection to the shared online space.

5. The method of claim 1, determining the interaction value, comprising:
determining a frequency factor for the user and member based on a frequency of a shared co-presence in the shared online space;
determining a recency factor for the user and member based on a time of the shared co-presence in the shared online space relative to a current time; and
combining the frequency factor and recency factor.

6. The method of claim 5, comprising:
determining an outside interaction factor for the user and member based on co-presence of the user and member in one or more outside shared online spaces; and
determining the interaction value by combining the outside interaction factor, frequency factor and recency factor.

7. The method of claim 1, determining the social network value based on a number of social network connections between the user and member, comprising one or more of:
determining a number of connections between the user and member on social network sites;
determining a number of indirect connections between the user and member;
determining content in common between the user and member;
determining a number of online member feeds subscribed to by the user; and
combining the social network connections to determine the social network value.

8. The method of claim 1, combining the interaction value and social network value comprising multiplying the interaction value and social network value together to get the relationship value as a product.

9. The method of claim 1, scaling representations of members based on the relationship value comprising scaling the visual representation of a first member larger than the visual representation of a second member where the first member's relationship value is higher than the second member's relationship value.

10. The method of claim 9, comprising scaling the visual representations of members to a desired size in the display based on the relationship value falling within a range of relationship values associated with the desired size.

11. The method of claim 1, comprising applying desired visual treatment to visual representations of the members in the display of the user's online space based on the relationship value associated with respective member representations.

12. The method of claim 11, the visual treatments comprising one or more of:
color schemes associated with portions of a scale of the relationship values;
dynamic visual properties associated with portions of a scale of the relationship values;
online display locations associated with portions of a scale of the relationship values; and
images associated with portions of a scale of the relationship values.

13. A system for presenting members of a shared online space to a user of the shared online space, comprising:
a data store disposed on computer-based data storage configured to store information used in determining a relationship value between the user and a member of the shared online space;
a relationship value determination component operably coupled with the data store and one or more computer-based processors, and configured to retrieve information from the data store and utilize the one or more processors to determine a relationship value between the user and a member of the shared online space, the relationship value determination component comprising:
an interaction value determination component configured to utilize information about the user's and member's co-presence in the shared online space to determine an interaction value; and
a social network value determination component configured to utilize information about the member's online feeds subscribed to by
the user to determine a social network value;
the relationship value determination component configured to combine the interaction value and social network value for the user and member to generate the relationship value;
a relationship value association component configured to associate the relationship value with a corresponding member visual representation; and
an image scaling component configured to scale respective two or more visual representations of members in a display of the user's shared online space to fit an available screen space based on the relationship value.

14. The system of claim 13, the interaction value determination component comprising:
a frequency determination component configured to determine a frequency factor for the user and member based on a frequency of a shared co-presence in the shared online space; and
a recency factor determination component configured to determine a recency factor for the user and member based on a time of the shared co-presence in the shared online space relative to a current time; and
the interaction value determination component configured to combine the frequency factor and recency factor to generate an interaction value.

15. The system of claim 13, the social network value determination component comprising:
a connections determination component configured to determine a number of connections between the user and member on social network sites; and
a feed determination component configured to determine a number of online member feeds subscribed to by the user; and
the social network value determination component configured to combine the number of connections and number of feeds to determine the social network value.

16. The system of claim 13, the image scaling component configured to scale visual representations of members in the user's display area according to the relationship value assigned to respective visual representations, where a first member's visual representation is scaled larger than a second member's visual representation if first member's relationship value is higher than the second member's relationship value.

17. The system of claim 13, comprising a visual treatment component configured to apply a desired visual treatment to visual representations of the members in the display of the user's online space based on the relationship value associated with respective member representations.

18. The system of claim 13, comprising a badging component configured to attach a badge component to the visual representation of the member that identifies available semantic application data.

19. A method for presenting members of a shared online space to a user of the shared online space, comprising:
determining a relationship value between the user and a member of the shared online space, comprising:
determining an interaction value for the user and member relationship based on the user's and member's co-presence in the shared online space, comprising:
determining a frequency factor for the user and member based on a frequency of a shared co-presence in the shared online space;
determining a recency factor for the user and member based on a time of the shared co-presence in the shared online space relative to a current time;
determining an outside interaction factor for the user and member based on co-presence of the user and member in one or more outside shared online spaces; and
determining the interaction value by combining the outside interaction factor, frequency factor and recency factor; and
determining a social network value for the user and member relationship based on a number of social network connections between the user and member, comprising:
determining a number of connections between the user and member on social network sites;
determining a number of online member feeds subscribed to by the user; and
combining the social network connections to determine the social network value;
associating the relationship value to a specified visual representation of the member used in the shared online space; and
scaling respective two or more visual representations of members in a display of the user's shared online space to fit an available screen space based on the relationship value, comprising scaling the visual representation of a first member larger than the visual representation of a second member where the first member's relationship value is higher than the second member's relationship value.

20. The method of claim 19, comprising attaching a badge component to the visual representation of the member that represents available semantic application data, where the available semantic application data comprises one or more of:
an application that can initiate execution of an online action relative to the member's visual representation upon activation; and
an application that can identify one or more of the following:
semantic information about the member's activity status online;
semantic information about the member's permissions with the shared online space; and
semantic information about the member's method of connection to the shared online space.
